(19) United States
(12) Patent Application Publication
(10) Pub. No.: US 2014/0041252 A1
(43) Pub. Date: Feb. 13, 2014

(54) ALUMINUM CHIP DRYERS

(71) Applicants: Chris Vild, Chagrin Falls, OH (US); Robert Bendlak, Solon, OH (US); James Grayson, Gurdon, AR (US); Mark Bolton, Shanghai (CN); Mark Reynolds, Toronto (CA); David Quilter, Syracuse, NY (US)

(72) Inventors: Chris Vild, Chagrin Falls, OH (US); Robert Bendlak, Solon, OH (US); James Grayson, Gurdon, AR (US); Mark Bolton, Shanghai (CN); Mark Reynolds, Toronto (CA); David Quilter, Syracuse, NY (US)

(73) Assignee: PYROTEK, INC., Solon, OH (US)

(21) Appl. No.: 13/955,156

(22) Filed: Jul. 31, 2013

Related U.S. Application Data
(60) Provisional application No. 61/677,690, filed on Jul. 31, 2012.

(51) Int. Cl. F26B 21/02

(52) U.S. Cl. CPC F26B 21/02
USPC 34/500; 34/202; 34/86

(57) ABSTRACT

In accordance with one aspect of an exemplary embodiment, a dryer for removing hydrocarbons and/or moisture from metal chips is provided. The dryer has a chamber including a top portion and a base portion. The top portion is comprised of a material having a higher emissivity than the material forming the base portion. A burner is provided which introduces heated gas into the top portion. A device for transporting the metal chips is provided in the base portion. The device receives the metal chips at an inlet and transporting the metal chips to an outlet.

### BACKGROUND

This disclosure relates to a method for the treatment of waste products, in particular, waste products of metals which are contaminated with water, oil and oleaginous cooling agents, and to an apparatus for carrying out such method.

When metals are machined, a number of waste products are automatically produced in the form of particles or chips, e.g. fillings, turnings, borings or machining chips. In the machining of metals, for example, aluminum and aluminum alloys, oil or oil containing cooling fluids may be employed. The machined chips will therefore be contaminated with oil. In a typical situation, the borings and turnings will include, by weight, from 2 to 20 percent of the cutting oil. The use of solvents will remove the oil from the oil-coated chips quite well. However, this is an expensive method and not desirable from an environmental point of view.

Nonetheless, recovery of the scrap borings, turnings and chips is desirable in view of the cost of basic materials. However, the high moisture and hydrocarbon content in the material creates a dangerous situation of moisture expansion or explosion within the furnace. In addition, the hydrocarbon content will create contamination, melt loss and excessive smoking. Accordingly, direct introduction of the material into a molten metal environment is, for all practical purposes, nearly impossible.

Various attempts have been made in the industry to overcome the foregoing problems by removing the moisture and hydrocarbons from the material. A recovery process used for chips is centrifuging and/or washing of the chips with a subsequent drying process. The washers will basically dissolve the hydrocarbon leaving the chips somewhat free of the hydrocarbons but still heavy with moisture. The wet material is then dried. The centrifuge can remove both hydrocarbon content and water to a certain extent. Also, several thermal dryers have been developed which uses various means of heating the products with hot air and require separate ducting, cyclone and pollution control system to treat the exhaust.

The present disclosure provides a description of an improved apparatus to provide scrap pieces having very low hydrocarbon and water content.

### BRIEF DESCRIPTION

In accordance with one aspect of an exemplary embodiment, a dryer for removing hydrocarbons and/or moisture from metal chips is provided. The dryer has a chamber including a top portion and a base portion. The top portion is comprised of a material having a higher emissivity than the material forming the base portion. A burner is provided which introduces heated gas into the top portion. A device for transporting the metal chips is provided in the base portion. The device receives the metal chips at an inlet and transports the metal chips to an outlet.

According to a second embodiment, a dryer for removing hydrocarbons and/or moisture from metal chips is provided. The dryer has an elongated chamber with an inlet end and an outlet end. The chamber includes a heat source. A conveyor is disposed asymmetrically within the chamber and extends between the inlet end and the outlet end.

### BRIEF DESCRIPTION OF THE DRAWINGS

FIG. 1 is a schematic illustration of a first dryer embodiment;

FIG. 2 is a schematic illustration of an alternative dryer embodiment.

### DETAILED DESCRIPTION

According to a representative embodiment, a two zone drying system is provided. Zone 1 is the main burner heated chamber where thermal oxidation of the VOC from the chips takes place. Zone 1 is a hotter radiant zone (about 1400° F.) with walls formed of a high emissivity material which radiates heat down to the chips on a screw conveyor in Zone 2 to aid in drying. The 1400° F. in Zone 1 thermally oxidizes the VOC exhaust from the drying process in Zone 2. Zone 2 is a somewhat cooler zone and uses a lower emissivity material. Zone 2 also receives recirculated air cooled to 1000° F. or lower from Zone 1. This air is cooled by an in-line heat exchanger 40 (HX) so the oxygen levels are kept low (no fresh air quenching) but fresh air quenching can be used as appropriate. The recirculation air also insures that the chips in Zone 2 do not get above 1000 F (where melting and oxidation occur).

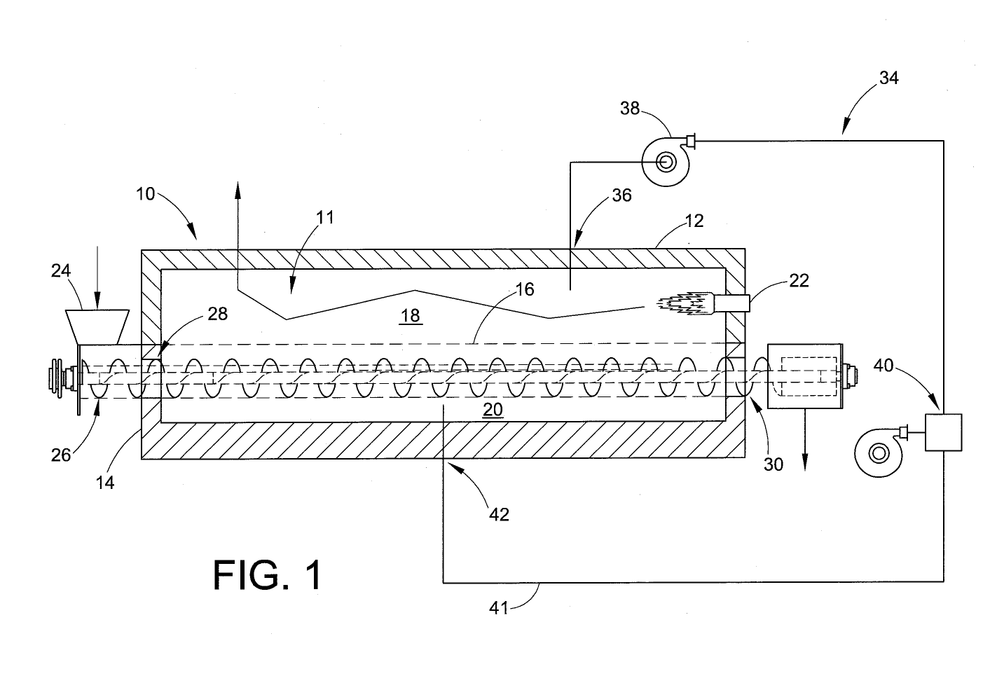

With reference to FIG. 1, a furnace 10 is provided which includes a top portion 12 constructed of a relatively high emissivity material such as graphite or silicon carbide and a lower portion 14 constructed of a relatively low emissivity material such as stainless steel. It is noted that the selected material can form just the exposed surface layer of the walls forming the relevant zone. The emissivity of a material is the relative ability of its surface to emit energy by radiation. It is the ratio of energy radiated by a particular material to energy radiated by a black body at the same temperature. In general, the duller and blacker a material is, the closer its emissivity is to 1 (a true black body). The more reflective a material is, the lower its emissivity generally is. Highly polished silver has an emissivity of about 0.02.

A baffle 16 constructed of silicon carbide divides the dryer chamber 11 into a top zone 18 and a bottom zone 20. The baffle can be a series of removable plates to allow the transfer of heat between zone 18 and zone 20 to be tailored as appropriate. Also, if it is desired to increase the heat transfer to the chips, the baffle can be a high emissivity material. Also to further lower the zone 2 temperature, cooling air may be added to zone 2.

A burner 22 is provided to introduce heated gas, for example, air at a temperature of at least 1400° F., into upper zone 18.

A hopper 24 is provided to receive chips and introduce the chips into screw conveyor 26. Screw conveyor 26 receives the chips through inlet 28 and transports the chips through lower zone 20, eventually exiting through outlet 30 where they are received in a molten metal melting furnace vortex, such as a Pyrotek LOTUSS system. A screw conveyor with a rotating scoop between screw flights may be desirable. As seen in FIG. 1, screw conveyor 26 can be disposed relatively closer to lower portion 14 of furnace 10 than to top portion 12.

A recirculating flow path 34 is provided for the heated gas within zone 18. Recirculating flow path 34 includes an outlet 36 from which high temperature gas is withdrawn from upper zone 18 and circulated via fan 38 to inline heat exchanger 40. Heat exchanger 40 reduces the temperature of the withdrawn air to 1000° F. or less which can then be reintroduced into the chamber 11 at lower zone 20 via path 41 and inlet 42. The temperature is adjusted (by a PID loop) by reading the temperature in Zone 2 and adjusting the HX fan speed accordingly (high fan speed decrease the temperature, lower fan speed increases the temperature). The recirculated air aids in drying the material by passing forced air through the bed of chips in the screw (forced convention).

The present device is advantageous because it combines dryer and thermal oxidizer in one low cost unit. Moreover, there is no requirement for a cyclone and duct work. Furthermore, the device can use a reducing atmosphere (low oxygen) to dry the chips which prevents combustion or oxidation of the aluminum and organics, allows for higher drying temperatures for high efficiency thermal heat transfer and allows for safer operation from an NFPA volatile organic concentration stand point (low oxygen=no combustion). In addition, the device yields higher temperature chips which is beneficial when introduced into molten metal. Furthermore, the device requires less air flow and lower velocity so aluminum fines are less likely to become airborne during the drying process.

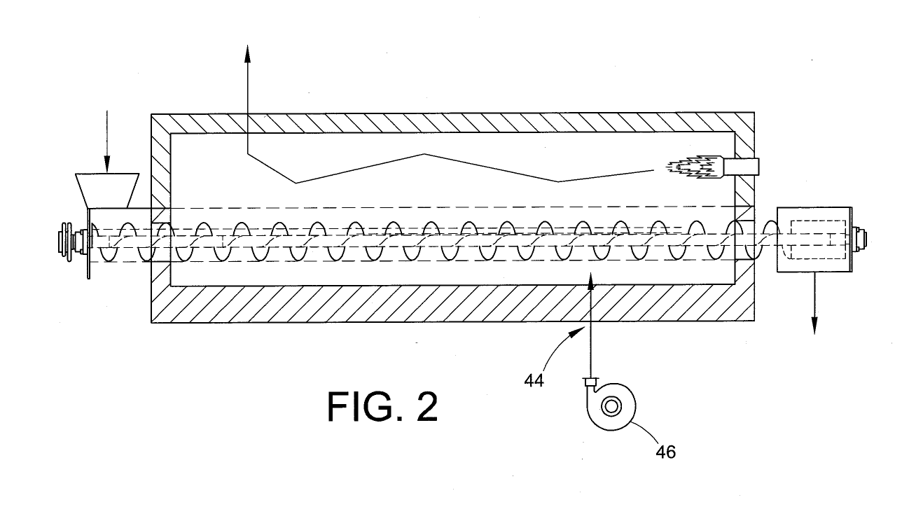

Turning next to FIG. 2, an alternative version of furnace 10 is depicted wherein the recirculating loop 34 is eliminated and an inlet 44 for introduction of fresh room temperature air is provided to reduce the temperature of lower zone 20. In this embodiment, a fan 46 is provided to introduce ambient air into zone 20 as a coolant (the cooling air then discharged to atmosphere). In this alternative, some of the air may be directed into the conveying zone as in FIG. 1, but this air would be high in oxygen levels.

The exemplary embodiment has been described with reference to the preferred embodiments. Obviously, modifications and alterations will occur to others upon reading and understanding the preceding detailed description. It is intended that the exemplary embodiment be construed as including all such modifications and alterations insofar as they come within the scope of the appended claims or the equivalents thereof.

1. A dryer for removing hydrocarbons and/or moisture from metal chips, the dryer comprising a chamber including a top portion and a base portion, the top portion comprised of a material having a higher emissivity, a burner located in the top portion to introduce a heated gas, a device for transporting the metal chips provided in the base portion, said device receiving the metal chips at an inlet and transporting the metal chips to an outlet.

2. The dryer of claim 1 wherein the base portion includes a port receiving cool air.

3. The dryer of claim 1 wherein the top portion is comprised of one of graphite and silicone carbide.

4. The dryer of claim 1 wherein the base portion is comprised of stainless steel.

5. The dryer of claim 1 wherein the device for transporting the chips comprises a screw conveyor.

6. The dryer of claim 1 further including a baffle disposed between the device for transporting the metal chips and a top wall of the chamber.

7. The dryer of claim 6 wherein the baffle comprises a plurality of removable plates.

10. A dryer for removing at least one of hydrocarbons and moisture from metal chips, the dryer comprising an elongated chamber having an inlet end and an outlet end and a heat source, a conveyor extending between the inlet end and the outlet end, wherein said conveyor is disposed asymmetrically within said chamber.

11. The dryer of claim 10 wherein said conveyor is disposed closer to a base wall of the chamber than to a top wall of the chamber.

12. The dryer of claim 10 further comprising a heat exchanger receiving air from said chamber and returning cooled air to said chamber.

13. The dryer of claim 12 wherein said cooled air is 1000° F. or lower.

14. The dryer of claim 12 wherein said dryer comprises a closed loop system.

15. The dryer of claim 10 wherein said chamber includes a first temperature zone between 700° F. and 1000° F. and a second temperature zone of at least about 1400° F.

16. The dryer of claim 10 wherein the heat source comprises a burner.

17. The dryer of claim 10 wherein recirculated air is introduced to said chamber.

18. The dryer of claim 10 including an inlet for the introduction of ambient air.

19. The dryer of claim 10 wherein said conveyor comprises a screw conveyor.

20. A method of melting metal chips comprising using the dryer of claim 10 to transport said chips to a melting furnace.
